(19) United States
(12) Patent Application Publication
(10) Pub. No.: US 2007/0201969 A1
(43) Pub. Date: Aug. 30, 2007

(54) Totes handling apparatus

(76) Inventors: John E. Dye, Glendora, CA (US); Dennis A. Allensworth, Corona, CA (US)

Correspondence Address: Boniard I. Brown, 1710 West Cameron Ave., #200, West Covina, CA, 91790, US

(21) Appl. No.: 11/712,339

(22) Filed: Feb. 27, 2007

Related U.S. Application Data
(60) Provisional application No. 60/777,414, filed on Feb. 27, 2006.

(51) Int. Cl. B65G 1/00

(52) U.S. Cl. 414/266

(57) ABSTRACT

The present invention comprises apparatus and methods to enable totes to be outwardly extended from supporting structures while retained in an extended position thus to accommodate the removal or insertion of items. The apparatus of the invention may typically be utilized with conventional warehouse equipment which has support beams and pins extending outwardly. Guide beams are provided atop support beams.

### CROSS-REFERENCE TO RELATED APPLICATIONS

Reference is made to our Provisional Application No. 60/777,414, filed Feb. 27, 2006, entitled Totes Handling Apparatus.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### SUMMARY AND BACKGROUND OF THE INVENTION

The present invention relates to apparatus and methods for use with totes and the like to enable totes to extend from supporting structures while being retained in an outwardly extended position for removal and insertion of items.

Apparatus according to the invention is shown in relation to conventional warehouse equipment with which it is generally utilized, having support beams with pins extending outwardly.

### BRIEF DESCRIPTION OF THE SEVERAL VIEWS OF THE DRAWINGS

FIGS. 1 and 2 show apparatus according to the present invention in relation to conventional warehouse equipment with which it is typically utilized;

FIGS. 3, 3A and 3B relate to a matrix of supports and guides for posts and related details;

FIGS. 4A to 4D show a hinge according to the invention in operation and extending downwardly into a tote;

FIGS. 5 and 6 show an overall assembly of totes disposed in respective racks, FIG. 5 being an elevational view and FIG. 6 being a side view;

FIGS. 7A, 7B, and 7C show a hinge according to the present invention in different configurations during operation; and

FIGS. 8 and 9 are front and rear views of a tote rack mounted on rollers for movement over warehouse floors and the like.

### DETAILED DESCRIPTION OF THE INVENTION

The present invention relates to apparatus and methods for use with assemblies for totes and the like which enable totes to be outwardly extended from supporting structures while being retained in an outwardly extended position to accommodate the removal or insertion of items.

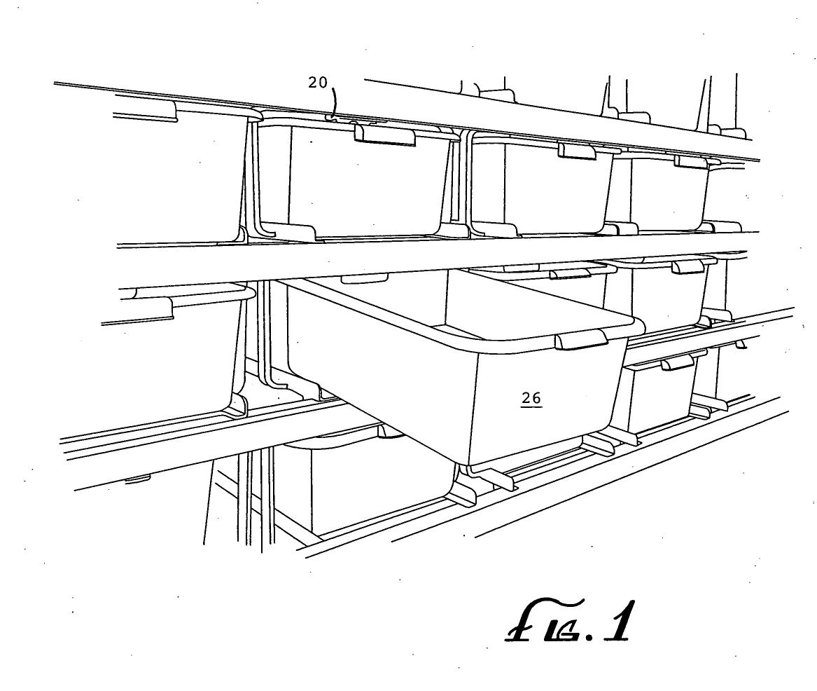

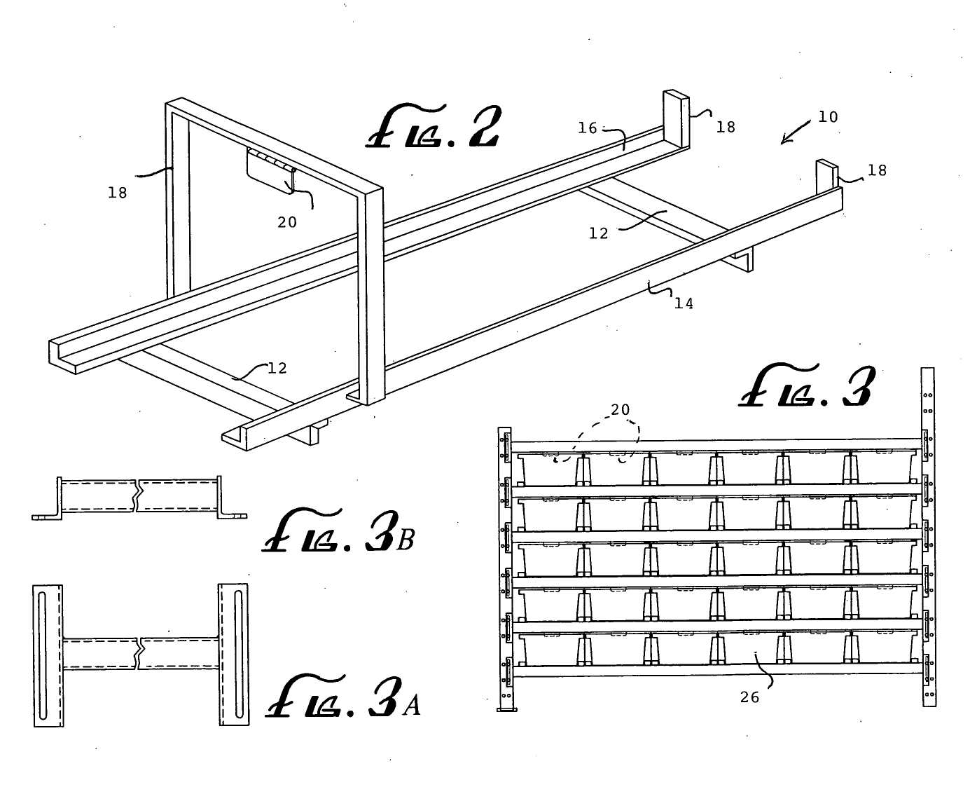

Referring to FIGS. 1 to 3 of the drawings, an apparatus 10 according to the invention is typically utilized with conventional warehouse equipment having support beams with pins extending outwardly from the side thereof. Guide beams are disposed atop the support beams. As shown in FIG. 3, a lattice may be made up of support beams fastened to various columns.

In FIG. 2, front and back transverse supports 12 support angle irons or guide beams 14, 16. The supports are welded in place in a spaced arrangement to mate up with the support beams, which are standard in the warehouse industry.

The supports 12 enable totes 26 to rest on horizontal portions of horizontal angle irons and be guided by the vertical portions of the angle irons 14, 16, the totes being retained by the vertical portions of the angle irons.

As shown in FIG. 3, the arrangement provides a matrix of supports and guides for posts, by providing a plurality of the guide structure or guide device of FIG. 2, and simplifies the supports and guides for totes.

The components are so sized and dimensioned that a tote 26 is positioned accurately between the guide beams 14, 16 (FIG. 2) and beneath a bonnet 18 of FIG. 2.

A metal bonnet 18 is secured as indicated in FIG. 2, as by welding, to each of the guide beams 14, 16. The bonnet 18 serves to position a hinge 20 at a correct height relative to a tote.

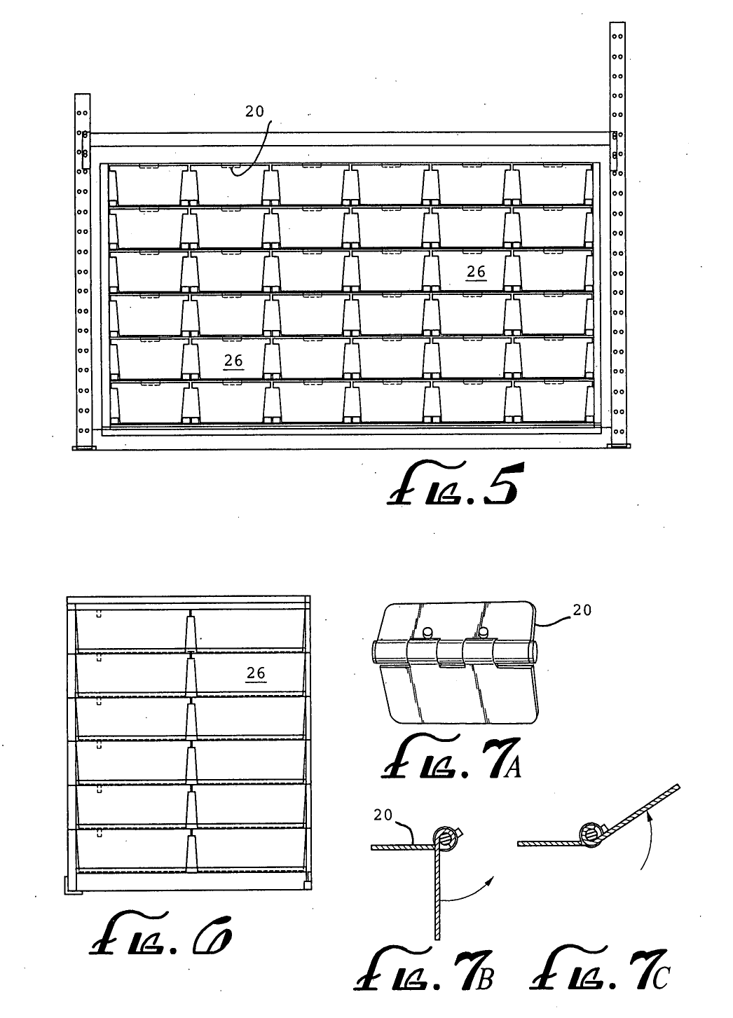

FIGS. 5 and 6 show another arrangement which serves the functions of the embodiment described above. Instead of the separate discrete small frames of FIG. 2 to support two end-to-end totes, the whole arrangement or frame comprises a matrix of support angles, bonnets and stop means. The entire mechanism can be set between standard columns in this arrangement, without requiring a separate support beam under each one.

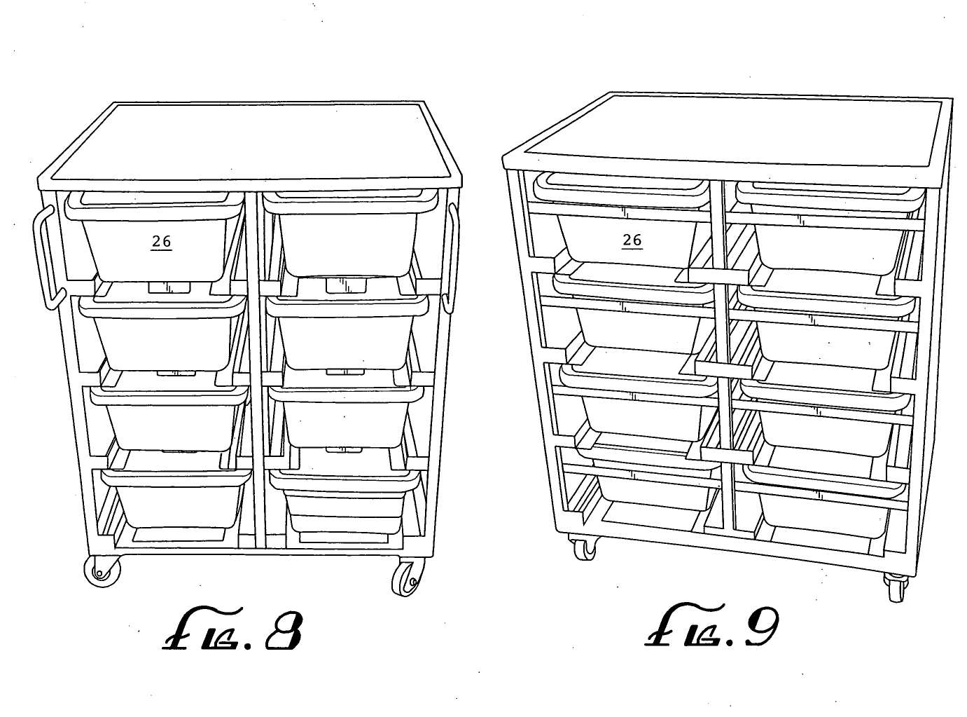

FIG. 7 shows a preferred embodiment of the hinge or guide structure of FIGS. 7A, 7B, and 7C.

The guide structure is conventional in the industry, including the members shown in FIG. 5, which comprise the left and right columns in FIG. 5, which mate with slots in the ends of support beams.

The structure of FIG. 2 is of course duplicated several times horizontally and several times vertically.

The arrangements of FIGS. 3 and 5 accomplish much the same results. Seventy-two totes are accommodated in the same heights, whereas only sixty can be accommodated in FIG. 3, because of the support beams (missing in FIG. 5) and shown in FIG. 3.

The arrangement shown in FIG. 5 accomplishes similar effect without requiring much space.

A hinge 20 is pivotally mounted relative to a side of a bonnet to enable it to pivot to a generally vertical orientation in a tote to prevent it from moving. The hinge 20 is disposed on a bonnet and is manually pivotable and extendable into the tote to shove it inwardly to prevent the tote from moving outwardly,

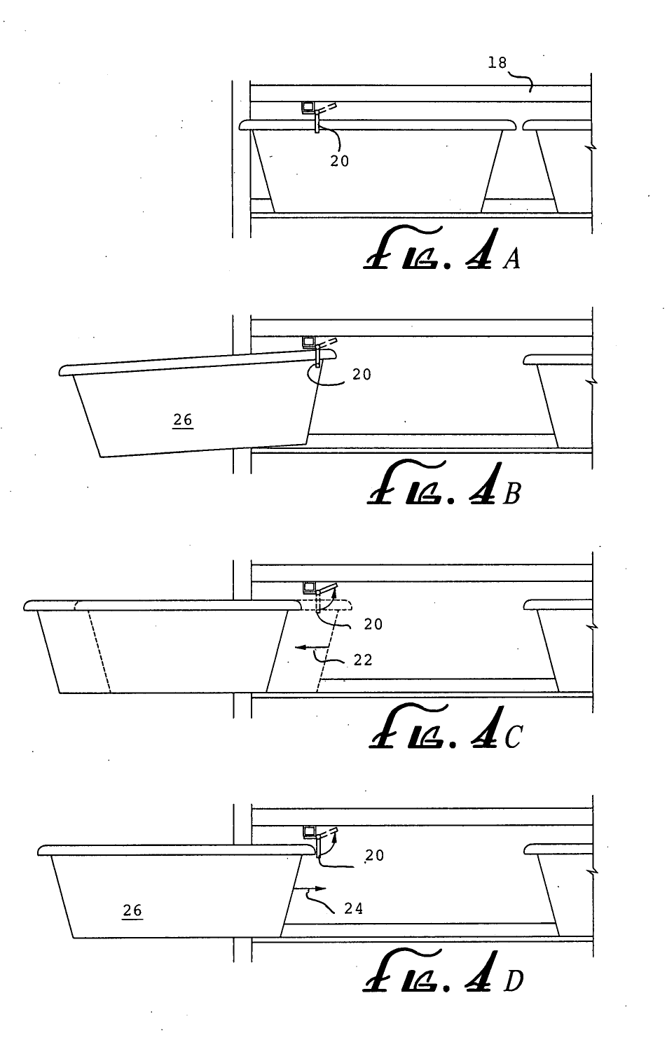

Hinge 20 is a feature of the present invention. Referring to FIGS. 4A-4D, the hinge is typically mounted on an inner side of the bonnet or on such structure as will allow it to depend downwardly just inside the tote. FIGS. 4A-4D show the insertion and removal of a tote.

The bonnet or guide structure 18, shown in FIGS. 4A, 4B is pivotally or hingedly mounted on a horizontal member, and serves to disengage a tote from a front lower edge of the guide means.

The insertion of a tote is shown in FIG. 4D, and the removal of a tote is shown in FIGS. 4A, 4B, 4C. Totes, which are heavy and generally contain substantial loads of hardware, etc., require that a person picking up the tote set its front lower edge on the two guide beams, as indicated in FIG. 4D. The person then need only push the tote inwardly to pivot the hinge 20. A person picking up the tote sets its front lower edge on the two guide beams shown in FIG. 4D. He then has only to push the tote inwardly and pivot the hinge upwardly so that it slides over the back edge of the tote and it falls downwardly, as indicated in FIG. 4D.

In the removal of a tote, a person must first locate the appropriate tote and pull it out. A tote may be quite heavy when containing a number of metal articles, etc.

The tote is held in position by the hinge or stop member as a person pulls the tote outwardly, as viewed in FIG. 4B. When a stop engages or bumps into the inside edge of the tote, as indicated in FIG. 4B, it is so spaced that the tote is supported on the bottom rail, as indicated in FIG. 4B. The operator can thus reach into the tote with both hands and does not have to manually support the tote, which is suspended.

in removing a tote, the operator need only push it back a short distance, reach in with his fingers in the direction of the arrow 22 in FIG. 4C, and then push the stop member upwardly by holding it up as indicated in FIG. 4C.

The operator needs only to shove a tote back in, because the hinge pivots in a backward direction as indicated in FIG. 4D. The operator thus prevents the tote from moving outwardly (as indicated in FIG. 4B) by shoving it inwardly as indicated by arrow 24 in FIG. 4D. The hinge prevents it from falling out as indicated in FIG. 4C by engaging the inner surface of a wall of a tote.

The racks are typically built so that they are two totes deep. A person can remove the first tote, reach in and pull out the second tote.

Referring to FIG. 4B a person reaching in must hold up the gravity-actuated stop or pivoting hinge 20. As he pulls the front end of a tote, he pulls a second tote leftward from its position shown in FIG. 4B, and back to engage a pivot. He must hold the pivoting hinge by hand.

FIGS. 8 and 9 are front and rear views of a roll-around cart, generally usable to carry totes.

In warehouses, particularly large parts ware-houses, the cart can roll about on concrete floors, etc., for handling and positioning of items.

It will be understood that various changes and modifications may be made from the preferred embodiment discussed above without departing from the scope of the present invention, which is established by the following claims and equivalents thereof.

1. A totes handling apparatus comprising:
a tote removable inwardly,
a hinge pivoting in a backward direction to enable an operator to prevent the tote from moving upwardly, the operator to remove a tote need only to push it back a short distance, then reach in and push and hold a stop member upwardly, and the operator can shove a tote inwardly, the hinge pivoting in a backward direction.
